(19) United States
(12) Patent Application Publication
(10) Pub. No.: US 2015/0162117 A1
(43) Pub. Date: Jun. 11, 2015

(54) SINTERED MAGNET AND PRODUCTION PROCESS THEREFOR

(71) Applicant: HITACHI, LTD., Tokyo (JP)

(72) Inventors: Matahiro Komuro, Tokyo (JP); Yuichi Satsu, Tokyo (JP); Takao Imagawa, Tokyo (JP)

(73) Assignee: HITACHI, LTD., Tokyo (JP)

(21) Appl. No.: 14/407,108

(22) PCT Filed: Jun. 13, 2012
(86) PCT No.: PCT/JP2012/065070

§ 371 Date: Dec. 11, 2014

(51) Int. Cl. H01F 1/057; H01F 41/02; H01F 7/02

(52) U.S. Cl. CPC H01F 1/0577; H01F 7/02; H01F 41/0266

(57) ABSTRACT

The purpose of the present invention is to improve the magnetic characteristics of a sintered magnet without adding a supplementary heavy rare earth element. A sintered magnet composed of an NdFeB main phase and a grain boundary phase, wherein: the grain boundary phase contains an oxyfluoride; the concentration of fluorine in the oxyfluoride decreases depthwise from the surface of the sintered magnet toward the center thereof; and the heavy rare earth element concentration of the oxyfluoride at the surface of the sintered magnet is nearly equal to that at the center thereof

### TECHNICAL FIELD

The present invention relates to a sintered magnet containing fluorine and a process for producing the same.

### BACKGROUND ART

A sintered magnet has been applied to various magnetic circuits. Especially, an NdFeB-based sintered magnet is a high-performance magnet including an Nd₂Fe₁₄B-based crystal as a main phase, and it is used in a wide range of products for motor vehicles, industry, power generation equipment, household appliances, medical services, electronic equipment, and the like, and the amount of the NdFeB-based sintered magnet used has increased. Expensive heavy rare earth elements such as Dy and Tb are used in the NdFeB-based sintered magnet for insuring heat resistance in addition to Nd which is a rare earth element. These heavy rare earth elements are skyrocketing in prices since they are rare; their resources are unevenly distributed; and resource conservation is required. Therefore, the requirement to reduce the amount of heavy rare earth elements used has been increasing.

As a technique capable of reducing the amount of heavy rare earth elements used, there has been known a grain boundary diffusion method in which a material containing a heavy rare earth element is applied to the surface of a sintered magnet and then diffused, and Patent Literature 1 discloses a sintered magnet to which this technique is applied. Further, Patent Literature 2 discloses a sintered magnet in which a technique of using a vapor containing a heavy rare earth element to diffuse the heavy rare earth element from the surface of the sintered magnet has been employed.

Patent Literature 3 discloses that, also in a sintered magnet in which a fluoride is applied and diffused into the surface of the sintered magnet, the amount of a heavy rare earth element used can be reduced, and an oxyfluoride is formed in a grain boundary of the sintered magnet.

Patent Literature 4 discloses that a fluorination technique using xenon fluoride fluorine can be applied to fluorine-interstitial compounds such as an SmFeF-based compound in which fluorine serves as a main phase of a magnet material.

Patent Literature 5 describes the concentration of a halogen element in a magnet produced by adding a fluoride followed by sintering. Further, Patent Literature 6 describes a fluorination technique using fluorine (F₂) gas.

### CITATION LIST

### Patent Literature

Patent Literature 1: WO 2009/513990
Patent Literature 2: JP-A-2009-124150
Patent Literature 3: JP-A-2008-147634
Patent Literature 4: JP-A-2011-211106
Patent Literature 5: JP-A-03-188241
Patent Literature 6: JP-A-06-244011

### SUMMARY OF INVENTION

### Technical Problem

In the above Patent Literatures 1 to 3, a material containing a heavy rare earth element is used, and the heavy rare earth element is diffused and unevenly distributed along a grain boundary from the surface of an NdFeB-based sintered magnet. These are techniques of adding from the outside the heavy rare earth element to an NdFeB-based sintered magnet which is a base material. In these prior arts, the heavy rare earth element is newly added by diffusion for improving magnetic characteristics of a sintered magnet, and it is difficult to realize improvement in the magnetic characteristics of the sintered magnet without additional use of a heavy rare earth element.

An object of the present invention is to improve the magnetic characteristics of a sintered magnet without adding a heavy rare earth element.

### Solution to Problem

One of the means to prepare a sintered magnet of the present invention is to employ a step of fluorinating a crystal grain boundary with a dissociative fluorinating agent to form an oxyfluoride and a fluoride in the crystal grain boundary at a low temperature, and then to perform a heat treatment at a temperature higher than the fluorination treatment temperature to thereby unevenly distribute an element having high compatibility with fluorine to the vicinity of the crystal grain boundary (abbreviated as grain boundary).

The dissociative fluorinating agent can generate a fluorine radical at a lower temperature than a diffusion heat treatment temperature and can fluorinate a magnet material at a low temperature of 50 to 400° C. A representative example thereof is xenon fluoride (Xe—based compound), with which fluorine can be easily introduced into a sintered magnet in the above temperature range. Dissociated fluorine is introduced into a sintered magnet, but xenon is hardly introduced into the sintered magnet because xenon is poor in reactivity and cannot easily form a compound with an element constituting the sintered magnet.

Since the dissociated or decomposed active fluorine is mainly introduced along the grain boundary where the concentration of a rare earth element and the concentration of oxygen are high and bonded to various elements constituting the sintered magnet, it is diffused into the grain boundary or the grain and forms various fluorine compounds (fluoride). In the case of a rare earth sintered magnet, an acid-fluorine compound (oxyfluoride) or a fluoride each containing a rare earth element easily grows. The oxyfluoride unevenly distributes a part of elements including magnet-constituting elements and trace additive elements, which are easily bonded to fluorine, and changes the composition and structure in the vicinity of the grain boundary.

Introducing only fluorine into the sintered magnet as described above significantly improves magnetic characteristics according to the following mechanisms. 1) The magnet-constituting elements or trace additives and impurities, which are easily bonded to fluorine, are diffused and unevenly distributed in the vicinity of the grain boundary. The uneven distribution provides effects such as an increase in magnetocrystalline anisotropy and an increase in the Curie temperature in a grain boundary, a grain boundary surface, and a main phase in the vicinity of the grain boundary. 2) Fluorine atoms at the grain boundary surface attract electrons and impart anisotropy to the electron density of states of adjacent crystals. 3) Since fluorine atoms have negative charge, the charge of a rare earth element is increased to the positive side in the vicinity of a high-concentration fluorine compound. An element having positive charge is attracted by fluorine having negative charge and unevenly distributed, and interface magnetic anisotropy is imparted by the change of charge. 4) The atomic arrangement in the interface of crystals which are adjacent to a fluoride and a crystal which contacts the interface is changed by the influence of the bias of the above electron density of states and charge balance, increasing the magnetocrystalline anisotropy energy in the vicinity of the interface. The change of composition and structure by introducing fluorine as described above influences magnetic properties in the vicinity of the fluoride and increases coercive force.

Specific techniques of the present invention will be described in Examples, but the features of representative sintered magnets having improved magnetic characteristics will be shown below. 1) Only dissociated fluorine is diffused from the surface of a sintered magnet, and the concentration of fluorine decreases from the surface of the sintered magnet toward the inner part. The concentration gradient of elements other than fluorine in an analysis area of 100 μm² from the surface of the sintered magnet toward the inner part thereof does not change before and after fluorination treatment, but the composition distribution in the vicinity of the grain boundary changes after fluorination treatment. This is because elements which are easily bonded to fluorine, such as Ga, Zr, Al, and Ti, are diffused and moved from the inside of a grain to the vicinity of a grain boundary by excessive fluorine introduced into the grain boundary. 2) The change of structural composition by the introduction of only fluorine is significant on the surface of the sintered magnet, and the change in the inner part is smaller than that on the surface of the sintered magnet. 3) When the grain boundary contains a rare earth element and oxygen, an oxyfluoride having a higher concentration of fluorine than the concentration of oxygen grows, and at least one element among elements constituting a magnet, additive elements, and impurity elements is unevenly distributed in the vicinity of the oxyfluoride, thus increasing the saturation magnetic flux density of a main phase. 4) The supplied fluorine is unevenly distributed in a grain boundary phase rather than in the main phase and forms the oxyfluoride which contains fluorine. A plurality of phases including the grain boundary phase constitute the sintered magnet, and the grain boundary phase which is most easily bonded to fluorine is mainly fluorinated. Only fluorine can be introduced into the sintered magnet utilizing the selectivity of fluorination as described above. Further, the oxyfluoride is a metastable phase and is converted to a stable phase when it is heated to the predetermined temperature or more.

The above features can be realized for the first time only by employing a technique capable of excessively supplying active fluorine to a sintered magnet material, and the uneven distribution of an element to which fluorine is previously added cannot be realized by a fluorine-introducing technique using the conventional stable fluoride or oxyfluoride.

### Advantageous Effects of Invention

The magnetic characteristics of a sintered magnet can be improved by the present invention without adding a heavy rare earth element.

### BRIEF DESCRIPTION OF DRAWINGS

FIG. 1 shows a concentration distribution after fluorination treatment.

FIG. 2 shows a concentration distribution after fluorination treatment.

FIG. 3 shows a concentration distribution after fluorination treatment.

FIG. 4 shows a structure of the cross section of a sintered magnet after fluorination treatment.

### DESCRIPTION OF EMBODIMENTS

Hereinafter, Examples of the present invention will be described.

### EXAMPLE 1

In a (Nd, Dy)₂Fe₁₄B sintered magnet, Cu, Ga, Al, and Co are mixed with a raw material powder before sintering each in a concentration range of 0.1 to 2 atom %, and the resulting powder is mixed with a powder having a higher concentration of a rare earth element than (Nd, Dy)₂Fe₁₄B, temporarily molded in a magnetic field, and then subjected to liquid phase sintering at 1000° C. The resulting sintered body is immersed in a slurry or a colloidal solution in which XeF₂ and a Co complex (β-diketone) are dispersed, which is heated to a temperature range of 50 to 150° C. Thereby, XeF₂ is decomposed to produce fluorine, which is introduced into the sintered body, and the Co complex is decomposed to produce Co, which is introduced into the sintered body from the surface thereof In this temperature range, the fluorine is deposited in the grain boundary, and the fluorine and Co are diffused in the grain boundary where the concentration of rare earth elements is high by the aging heat treatment after fluorine introduction.

The average particle size of XeF₂ is in the range of 0.1 to 1000 μm. XeF₂ having an average particle size of less than 0.1 μ.m easily sublimates, and it is difficult to supply a sufficient amount of fluorine to a sintered magnet. Further, if the average particle size exceeds 1000 μm, fluorination reaction is heterogenous, resulting in local generation of heat and growth of an oxide or an oxyfluoride containing residual oxygen, and it is difficult to diffuse fluorine in a grain boundary.

When fluorine is diffused in the grain boundary, composition, structure, interface structure, unevenly-distributed elements, and the like of the grain boundary and in the vicinity of the grain boundary changes largely, and the magnetic characteristics of a sintered magnet is improved. A part of a grain boundary phase before fluorine introduction changes with fluorination treatment from (Nd, Dy)₂O₃₋ₓ(0<x<3) to (Nd, Dy)ₓO_{y}F_{z} (where x, y, and z each represents a positive number). The concentration of Dy in (Nd, Dy)ₓO_{y}F_{z}, after the introduction of fluorine is lower than the concentration of Dy in (Nd, Dy)₂O₃₋ₓ(0<x<3), and the concentration of Nd in (Nd, Dy)ₓO_{y}F_{z} is higher than the concentration of Dy. Further, the concentration of fluorine in an oxyfluoride after fluorine introduction changes in the thickness direction of the sintered magnet; the concentration of fluorine is high on the surface of the magnet; and the concentration of fluorine is higher than the oxygen concentration of the oxyfluoride. Further, Dy in the grain boundary phase is diffused to the peripheral side of a main phase to promote the uneven distribution. Furthermore, fluorine is diffused into the grain boundary phase and the main phase by the introduction of fluorine, thus promoting the uneven distribution of additive elements such as Co, Al, and Ga in addition to Cu in the vicinity of the interface and decreasing the concentration of oxygen in the main phase. Furthermore, a part of Dy at the central part of the main phase crystal grain is diffused and unevenly distributed into the periphery of the grain boundary and a part of the grain.

A demagnetizing curve immediately after fluorine introduction is measured as a stepped demagnetizing curve having a distribution in coercive force. Fluorine and the main phase constituent element are diffused by aging heat treatment at 400 to 800° C., and a component having a small coercive force disappears from the demagnetizing curve. The saturation magnetic flux density after fluorine introduction is equivalent to that before the fluorine introduction. Unreacted fluorine and the like which are released from a sintered magnet can also be removed by aging heat treatment at 400 to 800° C. In a low-temperature aging heat treatment at less than 400° C., time is required for the diffusion of heavy rare earth elements and additive elements such as Cu, Al, Ga, and Co, which are diffused with fluorination. When aging is performed at a temperature higher than 800° C., fluorine is diffused to a grain boundary triple point and the like to relieve the uneven distribution of additive elements in the vicinity of a fluoride and an oxyfluoride, thereby making the coercive force after the fluorination treatment equal to the coercive force before the fluorination treatment. Therefore, the aging heat treatment temperature after fluorination treatment is preferably lower than 800° C.

In a magnet prepared under the preparation conditions of the present Example, a sintered magnet in which a maximum energy product is 40 MGOe or more and 70 MGOe or less has a Nd₂Fe₁₄B-based phase as a main phase, in which uneven distribution of rare earth elements and additive elements is observed on the peripheral side and in the inner part of the main phase crystal, and the proportion of the uneven distribution of the additive elements tends to be increased as it approaches the surface of the sintered magnet from the center thereof.

The fluorine introduction technique as described in the present Example can be applied to a Mn-based magnetic material, a Cr-based magnetic material, a Ni-based magnetic material, and a Cu-based magnetic material in addition to the (Nd, Dy)₂Fe₁₄B sintered magnet. Fluorine introduction into an alloy phase which does not show ferromagnetism before fluorine introduction, and ordering of the position of fluorine or ordering of an atomic pair of fluorine and another light element in the alloy phase largely changes the electronic state of a metal element to which a fluorine atom having high electronegativity is adjacent to thereby produce anisotropy in the distribution of electron density of states to produce ferromagnetism or hard magnetism.

In addition to utilizing the decomposition reaction of the XeF-based compound of the present Example, fluorine-containing radicals, fluorine-containing plasma, and fluorine-containing ions which are generated utilizing a chemical change of a compound between an inert gas element other than Xe and fluorine can be utilized as a fluorinated material for introducing fluorine, and the sintered magnet can be fluorinated by contacting or irradiating the surface of the sintered magnet with these fluorine-containing radicals, plasma, and ions. Further, although homogeneous reaction can be achieved by proceeding with these fluorination reactions in a solvent such as alcohol and mineral oil, fluorine can be introduced even when the solvent is not used.

### EXAMPLE 2

A technique of subjecting a (Nd, Dy)₂Fe₁₄B sintered magnet containing 1 wt % of Dy to fluorination treatment to increase coercive force will be described in the present Example. Coercive force can be increased by selectively introducing only fluorine into a grain boundary without using a metal element in fluorination treatment followed by low temperature heat treatment, this technique allowing magnetic characteristics to be improved in a low temperature step of less than 600° C. without using a rare metal element. A mixture of hexane (C₆H₁₄) and XeF₂ (0.1 wt %) are used as a fluorinating agent. The XeF₂ is previously pulverized in an inert gas atmosphere to particles having an average particle size of 1000 μm or less, which is then mixed with hexane. A sintered magnet is inserted into the resulting mixture, and the both are put into a Ni container and heated. Heating temperature is 120° C., and fluorination proceeds at this temperature. Diffusion heat treatment with fluorine is performed without exposing the sintered magnet to atmospheric air after fluorination. Diffusion heat treatment temperature is set to a higher temperature range than the heating temperature. The sintered magnet is kept at a diffusion heat treatment temperature of 500° C. and then rapidly cooled. The coercive force is increased by the fluorination treatment and the diffusion heat treatment. The results are shown in No. 1 and No. 2 in Table 1-1.

FIG. 1 shows the results of distributions of F, Nd, and Dy determined by mass spectrometry in the cross section of a sintered magnet having a thickness of 4 mm prepared under the conditions of No.2 in Table 1-1. Although the concentrations of Nd and Dy are almost constant in the thickness direction, the concentration of F is higher at points closer to the surface (2 mm). It has been confirmed by electron beam diffraction using an electron microscope that an oxyfluoride is rhombohedral or cubic in a region of 1.5 to 2 mm from the center of a magnet, and an oxyfluoride increases at points closer to the surface.

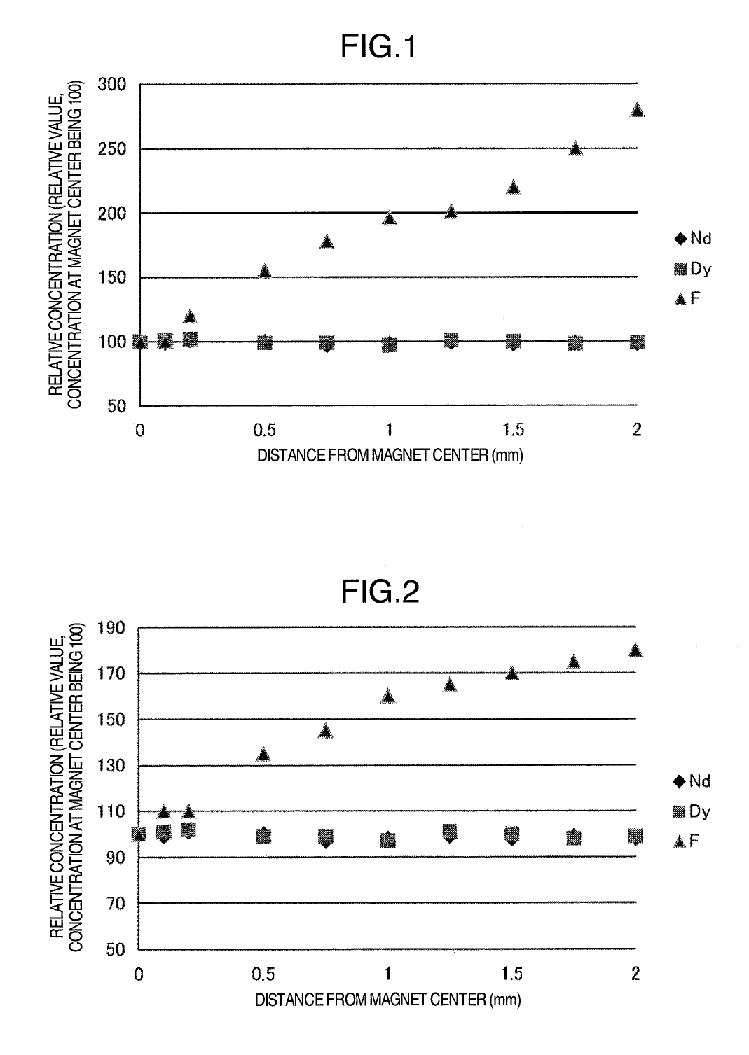

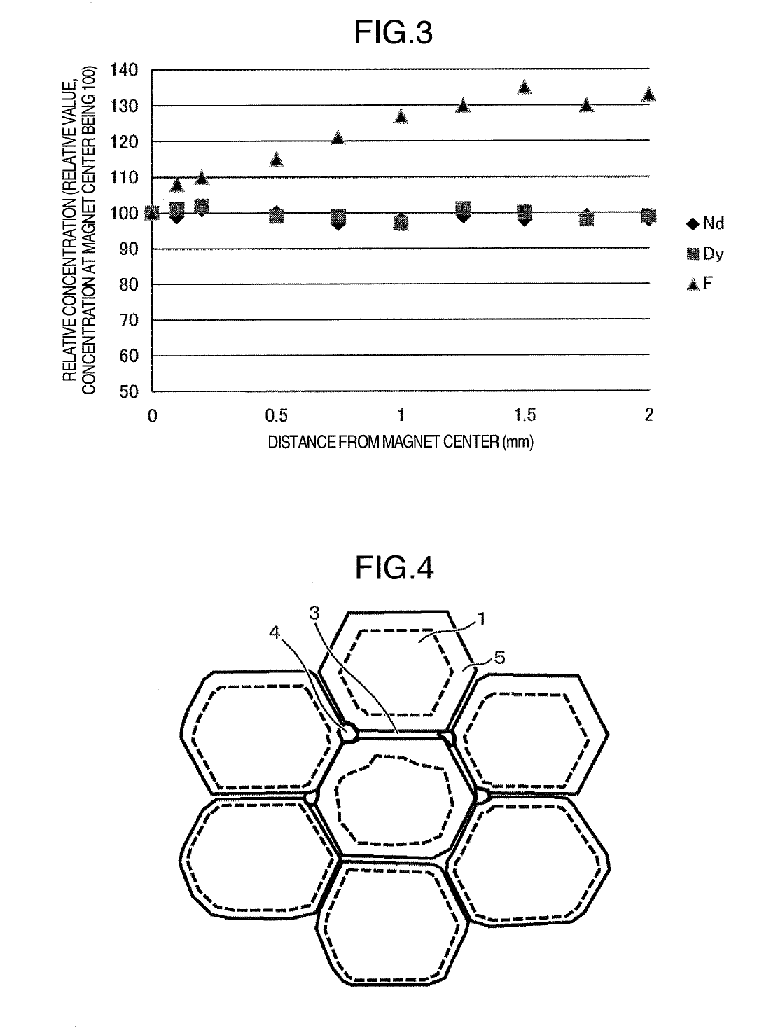

The diffusion heat treatment temperature is 500° C. in FIG. 1. When the diffusion heat treatment temperature is shifted to a higher temperature side of 550° C. or 600° C., the concentration distribution of fluorine changes as shown in FIG. 2 or FIG. 3, respectively. In the case of FIG. 1 and FIG. 2 in which a gradient of the concentration of fluorine is observed and a relative concentration ratio exceeds 30%, the coercive force has increased by 0.24 MA/m than that of an untreated magnet. On the other hand, in the case of FIG. 3 in which the concentration gradient of the concentration of fluorine is small, the effect of increase in coercive force is as small as less than 0.1 MA/m.

Table 14 to Table 1-5 show the results of applying fluorination treatment to various materials to be treated, in which the values of magnetic characteristics before and after the fluorination treatment are shown. It is found that the coercive force has increased from 2.00 MA/m to 2.10 MA/m under the above operation conditions. The magnet material in which an increase in coercive force by such fluorination treatment has been verified has features mainly in the following points.

1) An oxyfluoride of a rhombohedral or cubic structure is formed in a rare-earth rich phase, the concentration of fluorine in the oxyfluoride is distributed in the range of 10 to 70 atom %, and an average concentration of fluorine in the oxyfluoride of higher than 33 atom % in the vicinity of the surface within 100 μm from the outermost surface of the main phase crystal grain forms a composition suitable for the increase in coercive force. If the concentration of fluorine in the oxyfluoride exceeds 70 atom %, the structure of the oxyfluoride is unstable, and the coercive force is also reduced.

2) The concentration of fluorine tends to decrease depthwise from the surface of a magnet toward the inner part thereof and since treatment temperature is low, the concentration gradient of the fluorine concentration is higher than the concentration gradients of other elements than fluorine. The concentration of Dy at the center of the magnet is nearly equal to that at the surface thereof, and the difference in the concentration of Dy in the inner part of the magnet mainly comprising the main phase and the grain boundary phase and that in the vicinity of the surface thereof is within ±50%. On the other hand, when the concentration of fluorine at the surface of the magnet is higher than that at the central part thereof by more than 30%, an increase in coercive force is observed, and when the difference in the concentration of fluorine is more than 50% and 500% or less, the coercive force increases by 0.24 MA/m or more. That is, the increase in coercive force is remarkable when the difference in the concentration of fluorine is larger than the difference in the concentration of a heavy rare earth element such as Dy, and the concentration of fluorine at the surface of the magnet is higher than that at the central part of the magnet. Here, the analytical position on the surface of the magnet is within 100 μm depthwise from the outermost surface; the analysis area on the surface of the magnet and at the central part thereof is 50×50 μm²; and the evaluation can be performed by wavelength dispersive x-ray spectrometry.

3) The demagnetizing curve of a magnet before diffusion treatment shows a curve, in which at least two types of demagnetizing curves of a low coercive force layer and a high coercive force layer are overlapped, but after diffusion heat treatment, the shape of the demagnetizing curve changes, in which the low coercive force layer is integrated with the high coercive force layer.

4) Heavy rare earth elements are unevenly distributed at a higher concentration in the vicinity of the grain boundary after fluorination treatment than the concentration before fluorination treatment, and the uneven distribution of additive elements such as Ga, Cu, and Al in the grain boundary is also promoted. Particularly, additive elements such as Ga, V, and Mn having a low fluoride-forming energy, the low fluoride-forming energy showing that a fluoride which is more stable than Cu can be formed, are easily unevenly distributed in the grain boundary by fluorination treatment and contribute to an increase in coercive force together with the uneven distribution of heavy rare earth elements. Since fluorine participates in the uneven distribution of these elements, the uneven distribution is more remarkable on the surface than in the inner part of a sintered magnet. That is, the ratio of the additive elements in the peripheral part of a main phase crystal grain of the sintered magnet to that in the inner part thereof (the concentration of additive elements in the peripheral part of the main phase crystal grain and in the grain boundary/the concentration of additive elements in the central part of the main phase crystal grain) tends to be larger for the surface (peripheral part) of the sintered magnet than for the inner part thereof. This shows that the concentration distribution of additive elements of the sintered magnet tends to be equalized from the surface of the sintered magnet toward the inner part thereof, and, although the concentration of additive elements at the surface of the sintered magnet is nearly equal to that at the center thereof when the analysis area is 100×100 μm², the uneven distribution of additive elements in the vicinity of the grain boundary is more remarkable at positions closer to the surface of the sintered magnet when the analysis area is 10×10 nm².

5) If diffusion heat treatment temperature is set to a higher temperature than 900° C., fluorine is deposited at the grain boundary triple point and the like to partly produce an orthorhombic or hexagonal oxyfluoride different from the stable cubic structure, and uneven distribution of an additive element is relieved, thus reducing coercive force. Therefore, the diffusion heat treatment temperature is preferably in a temperature range equal to fluorination treatment temperature or more and less than 900° C., and in the case of an NdFeB system, a temperature range of 120 to 800° C. is suitable.

FIG. 4 shows a typical structure at a position 50 μm from the surface toward the center of a sintered magnet prepared under the conditions of No 2 in Table 1-1. A main phase crystal grain 1 having an Nd₂Fe₁₄B structure as a main phase includes an unevenly distributed additive element in a peripheral part 5 thereof, and fluorine is contained in a grain boundary phase 3. Further, an oxyfluoride such as NdOF is observed at a grain boundary triple point 4.

In the peripheral part 5 of the main phase crystal grain 1, uneven distribution of various additive elements can be observed in the range of less than 100 nm from the grain boundary. The concentration of the unevenly-distributed elements tends to be higher at a position close to the surface of the magnet.

Examples of fluorination solution that can be applied other than a mixed solution (slurry, colloid, or pulverized powder-containing solution) of hexane and XeF₂ include combinations of various low-temperature dissociative fluorides and mineral oil and a combination of a fluoride that can generate a fluorine radical and mineral oil or an alcohol-based treatment solution. It is also possible to add a metal fluoride to a low-temperature dissociative fluoride or a fluorine radical-generating material to introduce and diffuse unevenly distributed elements from the surface during fluorination treatment.

In the present Example, magnetic characteristics is not deteriorated even if a part of Xe is incorporated in the sintered magnet. Further, inevitably contained elements such as oxygen, nitrogen, carbon, hydrogen, sulfur, and phosphorus may be present. The (Nd, Dy)₂Fe₁₄B sintered magnet after fluorination treatment may contain a carbide, an oxide, a nitride, and the like in addition to an oxyfluoride, a fluoride, a boride, and an Nd₂Fe₁₄B-based compound. Further, fluorine may substitute for the boron site of an (Nd, Dy)₂Fe₁₄B crystal, or may be located at any point between the rare earth element and an iron atom, between an iron atom and boron, and between a rare earth element and boron thereof

As shown in Table 1-1 to Table 1-5, an increase in coercive force has been observed in various magnetic materials similar to (Nd, Dy)₂Fe₁₄B. An increase in coercive force can be observed even when a heavy rare earth element is not added, and a part of magnetization reversal sites is lost by the increase in magnetic anisotropy due to the uneven distribution of additive elements.

As shown in Table 1-1 to Table 1-5, the magnetic characteristics is improved by the fluorination treatment using the dissociative fluorinating agent which is easily decomposed without additionally using of a rare earth element. The improvement effect of magnetic characteristics can be confirmed also for an Nd2Fe14B-based sintered magnet in which Dy is diffused in the grain boundary as shown in the results of No. 51 to No. 60 in Table 1-3. The temperature of fluorination treatment is low, and is preferably in the range of 50 to 400° C. in the case of the Nd₂Fe₁₄B-based sintered magnet. Since dissociated fluorine is easily diffused and introduced into a rare earth-rich phase, the fluorination treatment can be performed at a lower temperature than conventional grain boundary diffusion treatment temperature.

In order to unevenly distribute an element added to the Nd₂Fe₁₄B-based sintered magnet to the vicinity of the grain boundary after the introduction of fluorine, it is desirable to add an element that easily forms a compound with fluorine. The element added can be diffused and unevenly distributed at an aging temperature of 500 to 600° C. by selecting an element that can more easily form a fluoride than iron in a matrix phase. It is effective in the improvement in magnetic characteristics such as an increase in coercive force to add Al, Cr, Mn, Zn, Zr, Si, Ti, Mg, Bi, or Ca in a concentration range that allows an uneven distribution in the vicinity of the grain boundary, wherein the free energy (Gibbs free energy) of the fluorides of these metals is lower than that of iron fluoride in the above temperature range.

### EXAMPLE 3

An (Nd, Pr, Dy)₂Fe₁₄B sintered magnet is mixed with a XeF₂ pulverized powder, and the mixture is kept at 100° C. The average particle size of the XeF₂ pulverized powder is 100 μm. The XeF₂ pulverized powder is sublimated, and fluorination proceeds from the surface of the (Nd, Pr, Dy)₂Fe₁₄B sintered magnet. Fluorine is mainly introduced into a grain boundary where the content of Nd, Pr, Dy, and the like is high; an oxide turns into an oxyfluoride; and the composition and structure in the vicinity of the oxyfluoride is changed. After being kept at 100° C., the sintered magnet is kept at 450° C. to diffuse fluorine along the grain boundary and then rapidly cooled through a temperature range of 450 to 300° C. at a cooling rate of 10° C./second or more to increase coercive force. A coercive force of 1.5 MA/m before treatment is changed to a coercive force of 2.1 MA/m after the treatment and diffusion/rapid cooling treatment.

The coercive force increase is based on the fluorine introduction step, and the coercive force can be increased even if a metal element such as a heavy rare earth element is not added. Introduction of fluorine turns an oxide or a rare earth-rich phase in the grain boundary into an oxyfluoride or a fluoride, in the vicinity of the surface of a sintered magnet. The oxyfluoride is a metastable cubic crystal, and a part of the elements which had been previously added to the sintered magnet is unevenly distributed in the vicinity of the grain boundary between the oxyfluoride and (Nd, Pr, Dy)₂Fe₁₄B. An element which is added before sintering and unevenly distributed during fluorine-introducing treatment is an element which more easily forms a fluoride than Cu, and is an element having a lower fluoride-forming energy (higher on a negative side) than that of CuF₂. Examples of such an element include Ti, V, Zr, Ga, and Al. An increase in coercive force after fluorination treatment can be realized by adding 0.01 to 2 wt % of such an element.

The investigation conditions of the present Example will be described below. The (Nd, Pr, Dy)₂Fe₁₄B sintered magnet is a sintered magnet in which 1 wt % of Dy and 5 wt % of Pr are added, and after fluorine-introducing treatment, Dy is unevenly distributed from the grain boundary phase to the vicinity of the interface between the grain boundary and the main phase ((Nd, Pr, Dy)₂Fe₁₄B crystal). Even in the case where Dy is not added, when an element which more easily forms a fluoride (MF₂) than Cu, such as Ti, V, Zr, Ga, and Al, or an element M which easily forms a fluoride (MF₂) that is more stable than the fluoride CuF₂, is previously added, the element M is diffused by the diffusion treatment after the introduction of fluorine to the vicinity of a portion where fluorine is unevenly distributed. Thereby, the M element is unevenly distributed to increase the coercive force. Fluorine easily forms an oxyfluoride, and the concentration of oxygen in the sintered magnet is preferably 3000 ppm or less, more preferably in the range of 100 to 2000 ppm. In order to remove oxygen in the vicinity of the surface, it is effective in the increase in coercive force to expose the sintered magnet to a reducing atmosphere before fluorination or to advance the above fluorination treatment in a reducing atmosphere.

XeF₂ mixed with the (Nd, Pr, Dy)₂Fe₁₄B sintered magnet is found to sublimate at 20° C., and a part thereof dissociates. Therefore, fluorination proceeds even at 100° C. or less. Although fluorine is introduced at a lower temperature than 50° C., an oxyfluoride is formed on the surface. The proportion of fluorine deposited on the surface as an oxyfluoride or a fluoride is higher than that of fluorine diffused along a grain boundary, and it is difficult to diffuse fluorine into the inner part of the sintered magnet in the diffusion treatment after fluorination treatment. Therefore, it is desirable to advance the fluorination treatment at 50 to 250° C. in the sintered magnet having a thickness of 1 to 5 mm.

The demagnetizing curve of the sintered magnet immediately after fluorination treatment has an inflection point in magnetic field that is 10 to 80% of the coercive force before sintering, which is generally a stepped demagnetizing curve or a demagnetizing curve in which low coercive force components are overlapped. This is because grain boundary width has been extended by the introduction of fluorine, and a part of the surface of the main phase crystal grain has been fluorinated. With respect to such a demagnetizing curve, the stepped demagnetizing curve or the demagnetizing curve in which low coercive force components are overlapped is changed to a curve similar to the demagnetizing curve before fluorination treatment by the next diffusion and aging heat treatment, thus increasing coercive force. The diffusion and aging heat treatment depend on grain boundary (grain boundary triple point and two-grain boundary) composition, main phase composition, particle size, the type of additives, the content of impurities such as oxygen, orientation, crystal grain shape, and directional relationships between crystal grains and between a crystal grain and a grain boundary.

In order to obtain larger coercive force than the coercive force before fluorination treatment, the diffusion heat treatment temperature after fluorination treatment needs to be 800° C. or less. If the temperature exceeds 800° C., the interface between oxyfluoride/main phase decreases, and fluorine is easily concentrated at the grain boundary triple point. Thus, an interface between a phase having a low concentration of fluorine and the main phase such as oxyfluoride/oxide/main phase increases; a part of uneven distributions of additives by fluorine disappears; and the effect of increase in coercive force is reduced. Therefore, the highest keeping temperature of the diffusion heat treatment temperature is preferably 300 to 800° C. When the temperature is less than 300° C., the effect of the uneven distribution of the additive element accompanying the diffusion of fluorine is small, and the aging time for securing the effect of the uneven distribution requires 20 hours or more for a sintered magnet having a thickness of 1 mm, which is poor in mass productivity.

In a sintered magnet of the present Example, the concentration of fluorine tends to decrease depthwise from the surface of the magnet toward the center of the magnet, and since the treatment temperature is low, the concentration gradient of fluorine is higher than the concentration gradients of other elements than fluorine. The concentrations of Dy and Pr in an analysis area of 50×50 μm² at the center of the magnet are nearly equal to those at the surface (within 100 μm from the surface) thereof, and the difference in the concentration of Dy in the inner part (at a position 10000 μm from the surface toward the center) of the magnet mainly comprising the main phase and the grain boundary phase and that in the vicinity of the surface (within 100 μm from the surface) thereof is within ±50%. On the other hand, when the concentration of fluorine on the surface of the magnet is higher than that at the central part thereof by more than 30%, an increase in coercive force is observed, and when the difference in the concentration of fluorine is more than 50% and 500% or less, the coercive force increases by 0.24 MA/m or more. When the difference in the concentration of fluorine is more than 500%, a part of the main phase is decomposed by generation of heat during the introduction of fluorine, thus reducing the coercive force. Further, when the difference in the concentration of fluorine is less than 30%, the coercive force-increasing effect is small because the amount of unevenly-distributed additive elements is small.

The following features have been observed in the sintered magnet of the present Example as compared with conventional magnets. 1) The concentration gradient of fluorine is observed from the surface of the sintered magnet toward the inner part thereof 2) In the vicinity of the interface between the oxyfluoride and the main phase adjacent to the oxyfluoride, at least one, preferably two or more of fluoride (MF₂, where M is an element other than a rare earth element, iron, boron, oxygen, and fluorine) forming elements such as Cu, Al, Zr, Ga, and V other than a heavy rare earth element are unevenly distributed in the vicinity of the interface between ReOₓF_{y} (where x and y are each a positive number) and the main phase. 3) The ratio of the concentration of the unevenly-distributed element in the vicinity of the interface with the fluoride to the concentration thereof at the central part of the crystal grain (the ratio of the average concentration of the unevenly-distributed element at positions within 10 nm from the interface/the concentration of the unevenly-distributed element at the central part of the main phase crystal grain) is 2 to 100. When the ratio of the concentration is less than 1.5, the coercive force-increasing effect is not observed. When the ratio of the concentration is more than 100, the amount of the unevenly-distributed element added is too large, decreasing the residual flux density by 10% or more. 4) The ratio of the concentration decreases from the surface of the sintered magnet toward the inner part thereof.

Since only fluorine is introduced into the sintered magnet by the fluorination treatment due to the features as described above, the concentration of elements other than fluorine which is the average concentration in a plurality of main phase crystal grains before fluorination treatment is nearly equal to that after the fluorination treatment. However, uneven distribution of a part of additive elements to the vicinity of the grain boundary is remarkably observed after the fluorination treatment, and the uneven distribution tends to be remarkable at positions closer to the surface of the sintered magnet.

A technique of increasing the coercive force while maintaining the residual magnetic flux density, such as a technique of increasing a coercive force of 1.5 MA/m to a coercive force of 2.1 MA/m after the fluorination treatment and the diffusion rapid cooling treatment as described in the present Example, can be achieved by introducing a halogen element other than fluorination. An additive element which easily forms a halide is selected and previously added in a dissolution step before sintering. The mixture can be sintered to unevenly distribute a part of the additive element after the halogenation treatment. It is also possible to increase coercive force by applying halogenation treatment to a temporary molded product after temporary molding in a magnetic field to unevenly distribute the halogen element and an additive element into the vicinity of a liquid phase after sintering.

### EXAMPLE 4

An Nd₂Fe₁₄B sintered magnet having an average particle size of the main phase of 1.5 μm is immersed in an alcoholic solution mixed with XeF₄ powder and heated to 120° C. at a heating rate of 10° C./min followed by keeping the mixture at the same temperature. The XeF₄ powder decomposes during heating, and the Nd₂Fe₁₄B sintered magnet is fluorinated. Xe does not react with the Nd₂Fe₁₄B sintered magnet, but only fluorine is mainly introduced into the Nd₂Fe₁₄B sintered magnet. The amount of fluorine to be introduced is 0.001 to 10 atom %, which depends on the volume and a surface state of the Nd₂Fe₁₄B sintered magnet, and the temperature and keeping time which are fluorination treatment conditions. The introduction of fluorine can be determined by verifying an oxyfluoride and a fluoride by mass spectrometry, wavelength dispersive x-ray spectrometry, and structural analysis. When the amount of fluorine introduced is insufficient, the amount can be adjusted by increasing the time for retreatment in the alcohol-based solution.

After fluorine is introduced, the fluorine is diffused into the inner part of the Nd₂Fe₁₄B sintered magnet by an aging heat treatment to increase coercive force. The formation of a cubic oxyfluoride can be observed when the magnet is heated to 400° C. at 5° C./min, kept at 400° for 1 hour, and then rapidly cooled. The magnet is preferably cooled through the Curie temperature at a rapid cooling rate of 10 to 200° C./min. A rare earth-rich phase or a rare earth oxide in the grain boundary is fluorinated to a higher degree than the main phase, and the coercive force is increased to a higher level than that of an untreated Nd₂Fe₁₄B sintered magnet by the diffusion by the aging heat treatment and by controlling the structure and composition distribution of the grain boundary phase. The amount of increase is larger than in the case of using a slurry or an alcoholic swelling solution of a rare earth fluoride or a metal fluoride, or in the case of fluorination with a fluorine-containing gas (such as F₂ and NHF₄), and an increase in coercive force of 0.1 to 5 MA/m can be observed.

If the amount of fluorine exceeds the range of 0.001 to 10 atom %, the crystal of the main phase is decomposed by fluorine entered the main phase of the Nd₂Fe₁₄B sintered magnet, and a ferromagnetic phase having a small coercive force is formed. This increases residual magnetic flux density, but leads to reduction in the temperature dependence of coercive force or reduction in square shape properties of a demagnetizing curve. Therefore, the amount of fluorine to be introduced is preferably 10 atom % or less, and is preferably 20 atom % or less in a part from the surface toward a depth of 100 μm. The concentration of fluorine in the grain boundary phase or the grain boundary triple point may be 10 atom % or more. In the case where an NdOF-based oxyfluoride has been formed, an increase in coercive force of the Nd₂Fe₁₄B sintered magnet is more remarkable when the concentration of fluorine is higher than the oxygen concentration.

The concentration of fluorine tends to decrease depthwise from the surface of the magnet toward the inner part thereof, and the concentration gradient is higher than concentration gradients of other elements than fluorine as the treatment temperature becomes lower. The concentration of Nd at the center of the magnet is nearly equal to that at the surface thereof, and the concentration of Nd in the inner part of the magnet mainly comprising the main phase and the grain boundary phase and that in the vicinity of the surface thereof is within 110%. On the other hand, when the concentration of fluorine at the surface of the magnet is higher than that at the center thereof by more than 20% and 500% or less, the coercive force increases by 0.1 MA/m or more. Here, the analytical position on the surface of the magnet is within 100 μm depthwise from the outermost surface; the analysis area on the surface of the magnet and at the central part thereof is 50×50 μm²; and the evaluation can be performed by wavelength dispersive x-ray spectrometry.

An additive element M (where M represents an element such as Cu, Al, Co, Ti, V, and Ga excluding rare earth elements, iron, and boron) is unevenly distributed between ReₓO_{y}F₇, (where Re represents a rare earth element; O represents oxygen; F represents fluorine; and x, y, and z each represents a positive number) and an Nd₂Fe₁₄B crystal as the main phase. The element M is unevenly distributed either on the Re,O_{y}F_{z} side of a ReₓO_{y}F_{z}/Nd₂Fe₁₄B interface, in the interface, or on the Nd₂Fe₁₄B side of the interface and contributes to an increase in coercive force. Uneven distribution of a part of the element M in the vicinity of the grain boundary is remarkable in the case of y<z in ReₓO_{y}F_{z} (where Re represents a rare earth element; 0 represents oxygen; F represents fluorine; and x, y, and z each represents a positive number), and an increase in coercive force by fluorination is caused by uneven distribution of the element M and the formation of a high concentration oxyfluoride.

The uneven distribution of the element M shows a degree of enrichment of composition in which the ratio of the average value of the concentration of the element M within 20 nm from the above ReₓO_{y}F_{z}/Nd₂F₁₄B interface to that at the central part of the main phase crystal grain is 2 to 100, and the degree of enrichment tends to increase from the center of the sintered magnet toward the surface thereof Here, when compared before and after fluorination treatment, the analysis results of the concentration of additive elements other than fluorine are almost the same, in which the composition was analyzed depthwise in an area of 100×100 μm² (area of a plane parallel to the surface of the sintered magnet).

The change in the uneven distribution can be determined by mass spectrometry, wavelength dispersive x-ray spectrometry, and the like. The composition of planes parallel to the surface of the sintered magnet was analyzed in an area of 0.1×0.1 mm² at depths of 0.1 mm and 1 mm (planes parallel to the surface), and the composition was found to be almost the same. However, when the sintered magnet was subjected to fluorination treatment, only fluorine differed in composition, and the concentration of elements other than fluorine was found to be almost the same in an area of 0.1×0.1 mm² at depths of 0.1 mm and 1 mm (planes parallel to the surface). The local distribution of the composition in the grain boundary, the grain boundary triple point, and the vicinity of different phases in a grain is different in an area of 0.1×0.1 mm² at depths of 0.1 mm and 1 mm (planes parallel to the surface). That is, the distributions of the composition in an interface between the different phases which differs in crystal structure or composition from the main phase and the main phase and in a region within 100 nm from the interface are changed by the fluorination treatment.

By the fluorination treatment, a part of additive elements contained in the main phase is unevenly distributed in an interface of the fluoride or the oxyfluoride and in the vicinity (within 100 nm) of the interface, and the magnetic properties of the main phase in the vicinity of the interface, the interface, and the grain boundary phase are changed. An element that is easily bonded to fluorine, an element that stabilizes the fluoride or the oxyfluoride, an element that functions to return the imbalance of electronegativity by the fluorination, holes, and the like gather in the vicinity of the interface. As a result, local magnetic properties of the main phase change, leading to the increase in coercive force.

Further, an Nd-containing oxyfluoride is more stable than an oxyfluoride of Dy or Tb due to the difference of the free energy for each element of a fluoride or an oxyfluoride by the introduction of fluorine, and the composition of the grain boundary phase is changed by the introduction of fluorine. That is, a heavy rare earth element such as Dy is diffused and unevenly distributed to the main phase side, and Nd is diffused to the grain boundary phase from the main phase. As a result, the saturation magnetic flux density of the main phase is increased, and the magnetociystalline anisotropy in the vicinity of the grain boundary is increased, thus increasing the coercive force.

A fluorinating agent for the introduction of fluorine is preferably a material containing an inert gas element and fluorine as described in the present Example. Such a material allows easy introduction of fluorine at a lower temperature than the temperature of fluorination with a fluorine gas (F₂) or a fluoride such as ammonium fluoride (NH₄F) and a rare earth fluoride. It is possible to fluorinate the sintered magnet material at a low temperature using a slurry or a colloidal solution in which a material containing an inert gas element and fluorine is mixed with an alcohol or mineral oil; or a mixture of a material containing an inert gas element and fluorine with the fluorine gas (F₂); or a mixed and dispersed solution, a mixed slurry, or a mixed alcohol swelling liquid of a material containing an inert gas element and fluorine with a fluoride such as ammonium fluoride (NH₄F) and a rare earth fluoride or an oxyfluoride; or a solution in which a material containing an inert gas element and fluorine has gelled or solated.

### EXAMPLE 5

An Nd₂Fe14B sintered magnet having an average particle size in the main phase of 4 μm is exposed to Dy vapor at 900° C. to diffuse Dy along the grain boundary. Then, the Dy grain boundary diffusion sintered magnet is immersed in an alcoholic solution mixed with XeF₂ powder and heated to 100° C. at a heating rate of 10° C./min followed by keeping the mixture at the same temperature. The XeF₂ powder decomposes during heating, and the Nd₂Fe₁₄B sintered magnet is fluorinated. Xe does not react with the Dy grain boundary diffusion Nd₂Fe₁₄B sintered magnet, but only fluorine is mainly introduced into the Dy grain boundary diffusion Nd₂Fe₁₄B sintered magnet. The amount of fluorine to be introduced is 0.01 to 10 atom % in the vicinity of the surface within a depth of 10 um of the sintered magnet, which depends on the volume and a surface state of the Dy grain boundary diffusion Nd₂Fe₁₄B sintered magnet, fluorination treatment conditions, and a fluoride stabilizer added to the solvent. The concentration and composition distribution in the introduction of fluorine can be determined by verifying an oxyfluoride and a fluoride by mass spectrometry, wavelength dispersive xray spectrometry, and structural analysis. When the amount of fluorine introduced is insufficient, the amount can be adjusted by retreatment with the alcoholic solution, by increasing treatment time, or by adding an additive for accelerating the decomposition of the fluoride to the solution.

After fluorine is introduced, the fluorine is diffused to the inner part of the Dy grain boundary diffusion Nd₂Fe₁₄B sintered magnet and a metastable oxyfluoride is formed in the vicinity of the grain boundary by aging heat treatment to unevenly distribute additive elements to thereby increase coercive force. The formation of a cubic oxyfluoride can be observed when the magnet is heated to 500° C. at 5° C./min, kept at 500° C. for 1 hour, and then rapidly cooled. The magnet is preferably cooled in the vicinity of the Curie temperature at a rapid cooling rate of 10 to 200° C./min. A rare earth-rich phase or a rare earth oxide in the grain boundary is fluorinated to a higher degree than the main phase, and the coercive force is increased to a higher level than that of an untreated Dy grain boundary diffusion Nd₂Fe₁₄B sintered magnet by the diffusion by aging heat treatment and by controlling the structure and the composition distribution of the grain boundary phase. The amount of increase is larger than in the case of using a slurry or an alcoholic swelling solution of a rare earth fluoride or a metal fluoride, or in the case of fluorination with a fluorine-containing gas (such as F₂ and NHF₄), and an increase in coercive force of 0.5 to 5 MA/m can be observed as compared with the Dy grain boundary diffusion sintered magnet into which fluorine is not introduced.

When the amount of fluorine exceeds 15 atom % in the vicinity of the surface, the crystal of the main phase is decomposed by fluorine entered the main phase of the Dy grain boundary diffusion Nd₂Fe₁₄B sintered magnet, and a ferromagnetic phase and a nonmagnetic phase each having a small coercive force is formed. This increases residual flux density, but leads to reduction in the temperature dependence of coercive force or reduction in square shape properties of a demagnetizing curve. Therefore, the amount of fluorine to be introduced is preferably 10 atom % or less based on the whole magnet, and is preferably 15 atom % or less in a part from the surface toward a depth of 100 μm. The concentration of fluorine in the grain boundary phase or the grain boundary triple point may be 5% or more described above. In the case where an NdOF-based oxyfluoride has been formed, an increase in the coercive force of the Dy grain boundary diffusion Nd₂Fe₁₄B sintered magnet is more remarkable when the concentration of fluorine is higher than the concentration of oxygen.

The oxyfluoride formed is represented by ReₓO_{y}F_{z} (where Re represents a rare earth element; O represents oxygen; F represents fluorine; and x, y, and z each represents a positive number), and a compound in which y<z grows in the grain boundary at a higher volume rate than a compound in which y>z. For example, fluorine content is higher than oxygen content by local analysis even when the oxyfluoride has a crystal structure of NdOF. An oxyfluoride of the cubic structure and an oxyfluoride of the tetragonal structure are formed; the concentration of fluorine in the tetragonal oxyfluoride is higher than that in the cubic oxyfluoride; and the proportion of the tetragonal oxyfluoride increases from the center of the cross section of the sintered magnet toward the surface thereof. Further, oxygen is detected by local analysis even in fluorine compounds represented by ReFₙ (where n=2, 3, 4, or 5) such as NdF₂ and NdF₃, and it can be analyzed that the concentration of oxygen<the concentration of fluorine. A layer in which the concentration of fluorine is higher than the concentration of oxygen is formed by fluorination treatment in the grain boundary phase having a rare earth-rich composition. Such a distribution of the concentration of fluorine is different between the surface of the sintered magnet and the central part thereof, and the concentration of fluorine tends to decrease toward a position which is away from the fluorinated surface.

An additive element M (where M represents an element such as Cu, Al, Co, Ti, V, and Ga excluding rare earth elements, iron, and boron) is unevenly distributed between the ReₓO_{y}F_{z} (where Re represents at least two of rare earth elements; O represents oxygen; F represents fluorine; and x, y, and z each represent a positive number) and an Nd₂Fe₁₄B crystal as the main phase. The element M is unevenly distributed either on the ReₓO_{y}F_{z} side of a ReₓO_{y}F_{z}/Nd₂Fe₁₄B interface, in the interface, or on the Nd₂Fe₁₄B side of the interface and contributes to an increase in coercive force. Uneven distribution of a part of the element M in the vicinity of the grain boundary is remarkable in the case of y<z in ReₓO_{y}F_{z} (where Re represents at least two elements of rare earth elements; O represents oxygen; F represents fluorine; and x, y, and z each represent a positive number), and the increase in coercive force by the fluorination is caused by the uneven distribution of the element M and holes, the formation of a high concentration oxyfluoride, the diffusion and uneven distribution of Dy contained in the grain boundary phase to the main phase, and the lattice matching between the grain boundary phase and the main phase interface.

A fluoride and an oxyfluoride grown at a part of the grain boundary triple point have a higher concentration of fluorine than the concentration of oxygen and contain the element M, in which the concentration of the element M in the inner part of the fluoride and the oxyfluoride is different from that in the peripheral part thereof. The concentration of the element M is high in a fluoride having a high concentration of fluorine or in the vicinity thereof; uneven distribution of the element M is observed; and the uneven distribution is more remarkable in the vicinity of the surface of the sintered magnet than in the inner part and at the central part thereof. That is, although the average composition of components other than fluorine and Dy is almost equal at the center and in the inner part, the distribution of constituent elements has been changed by the introduction of fluorine; a part of elements has gathered around the fluoride or the oxyfluoride; and local uneven distribution and concentration gradient have occurred. Such a change in the composition distribution can be determined by mass spectrometry, wavelength dispersive x-ray spectrometry, and the like. The composition of planes parallel to the surface of the sintered magnet was analyzed in an area of 0.1×0.1 mm² at depths of 0.1 mm and 1 mm (planes parallel to the surface), and the composition was found to be almost the same. However, when the sintered magnet is subjected to fluorination treatment, only fluorine differs in composition, and the concentration of elements other than fluorine is found to be almost the same in an area of 0.1×0.1 mm² at depths of 0.1 mm and 1 mm (planes parallel to the surface) as compared before and after fluorination treatment. The local distribution of the composition in the grain boundary, in the grain boundary triple point, and in the vicinity of different phases in a grain is different in an area of 0.1×0.1 mm² at depths of 0.1 mm and 1 mm (planes parallel to the surface). That is, the distribution of the composition in the interface between different phases which differ in crystal structure or composition from the main phase and the main phase and that in a region within 100 nm from the interface are changed by fluorination treatment.

By fluorination treatment, a part of additive elements in the main phase is unevenly distributed in an interface of a fluoride or an oxyfluoride and in the vicinity (within 100 nm) of the interface, and the magnetic properties of the main phase in the vicinity of the interface, the interface, and the grain boundary phase are changed. An element that is easily bonded to fluorine, an element that stabilizes a fluoride and an oxyfluoride (Al, Cu, Ti, Zr, Mn, Co, Sn, Si, Cr, V, Ga, or Ge), an element forming a positive ion that is intended to return the imbalance of electronegativity by fluorination, holes, and the like gather in the vicinity of the interface. As a result, local magnetic properties of the main phase change. Such a phenomenon leads to an increase in coercive force.

Further, an Nd-containing oxyfluoride is more stable than an oxyfluoride of Dy or Tb based on the values of free energy for each element of a fluoride or an oxyfluoride by the introduction of fluorine, and the composition of the grain boundary phase is changed by the introduction of fluorine. That is, Dy diffused along the grain boundary is diffused and unevenly distributed to the main phase side, and Nd is diffused to the grain boundary phase from the main phase. As a result, the magnetocrystalline anisotropy of the main phase is increased, thus increasing the coercive force.

A fluorinating agent for the introduction of fluorine is preferably a material containing an inert gas element and fluorine as described in the present Example. Such a material allows easy introduction of fluorine at a lower temperature than the temperature of fluorination with a fluorine gas (F₂) or a fluoride such as ammonium fluoride (NH₄F) and a rare earth fluoride. it is possible to fluorinate a Dy grain boundary diffusion sintered magnet material at a low temperature using a slurry or a colloidal solution in which a material containing an inert gas element and fluorine is mixed with an alcohol or mineral oil; or a mixture of a material containing an inert gas element and fluorine with a fluorine (F₂) gas; or a mixed and dispersed solution, a mixed slurry, or a mixed alcohol swelling liquid of a material containing an inert gas element and fluorine with a fluoride such as ammonium fluoride (NH₄F) and a rare earth fluoride or an oxyfluoride; or a solution in which a material containing an inert gas element and fluorine has gelled or solated.

As described in the present Example, the metastable oxyfluoride and fluoride are formed when the concentration of fluorine is higher than the concentration of oxygen, and the unevenly distributed element can be observed in the vicinity of these metastable compounds, thus improving magnetic characteristics. In order to leave fluorine in the vicinity of an interface such as grain boundary, it is desirable to previously add 0.1 to 5 wt % of an element having an energy for forming a fluoride (MF₂ and MF₃) or an oxyfluoride (MOF) that is higher on a negative side than that of Cu, as an additive element. Since the energy for forming CuF₂ is −542.7 kJ/mol at 298K, an element M for forming CoF₂ (−692 kJ/mol), CrF₂ (−778 kJ/mol), SiF₂ (−664 kJ/mol), CaF₂ (−1228 kJ/mol), or the like is previously added. Excessive fluorine is supplied and diffused to the grain boundary by fluorination with dissociative fluorine such as radical fluorine. Thereby, the additive element (M) which easily forms a fluoride or an oxyfluoride is unevenly distributed in the vicinity of the grain boundary, allowing an increase in coercive force.

A part of fluorine may be arranged at an interstitial position of an Nd₂Fe₁₄B crystal lattice, or at an interstitial position or a substitution position of the grain boundary phase, Such fluorine in the main phase is the element for forming a more stable fluoride or oxyfluoride when it is heated to a higher temperature than the aging treatment temperature. When the amount of fluorine contained in an Nd₂Fe₁₄B crystal lattice is 0.01 to 10 atom % relative to Nd₂Fe₁₄B, a bct structure which is the crystal structure of the main phase can be maintained, and the direction of magnetocrystalline anisotropy (c-axis direction) is not changed. When 10 atom % or more of fluorine is contained in an Nd₂Fe₁₄B crystal lattice, the bct structure is largely distorted and unstable, and the direction of magnetocrystalline anisotropy shifts from the c-axis direction. Therefore, the fluorine content is preferably 10 atom % or less. Although it is difficult to specify the lower limit of fluorine contained in the main phase, when the growth of fluoride or oxyfluoride can be verified by heating only the main phase to 800° C. or more, a part of the fluorine is contained in the main phase crystal grain, and a concentration of fluorine of 0.01 atom % or more can be analyzed.

TABLE 1-1

| | | | Particle size | | | | | |
|---|---|---|---|---|---|---|---|---|
| | | | of fluoride | | Diffusion | | Residual | |
| | | | in treatment | Treatment | heat treatment | Coercive | magnetic | |
| | Material to | Main components in | solution | temperature | temperature | force | flux density | |
| No. | be treated | treatment solution | (μm) | (° C.) | (° C.) | (MA/m) | (T) | Remarks |
| 1 | (Nd, Dy)₂Fe₁₄B | — | — | — | — | 2.00 | 1.40 | Values before |
| 2 | (Nd, Dy)₂Fe₁₄B | Hexane (C₆H₁₄), XeF₂(0.1 wt %) | <1000 | 100 | 500 | 2.10 | 1.40 | treatment in |
| 3 | (Nd, Dy)₂Fe₁₄B | Hexane (C [symbol] H₁₄), XeF₂(0.1 wt %) | <100 | 100 | 500 | 2.20 | 1.41 | No. 2-14 |
| 4 | (Nd, Dy)₂Fe₁₄B | Hexane (C [symbol] H₁₄), XeF₂(0.1 wt %) | <10 | 100 | 500 | 2.35 | 1.41 | |
| 5 | (Nd, Dy)₂Fe₁₄B | Hexane (C₅H₁₄), XeF₂(0.5 wt %) | <10 | 100 | 500 | 2.52 | 1.42 | |
| 6 | (Nd, Dy)₂Fe₁₄B | Hexane (C₆H₁₄), XeF₂(1.0 wt %) | <10 | 150 | 450 | 2.68 | 1.45 | |
| 7 | (Nd, Dy)₂Fe₁₄B | Heptane (C₇H₁₆), XeF₂(1.0 wt %) | <10 | 150 | 450 | 2.74 | 1.45 | |
| 8 | (Nd, Dy)₂Fe₁₄B | Heptane (C [symbol] H₁₆), XeF₂(5.0 wt %) | <10 | 150 | 440 | 2.83 | 1.51 | |
| 9 | (Nd, Dy)₂Fe₁₄B | Hexane (C₆H₁₄), XeF₂(0.1 wt %), | <10 | 100 | 500 | 2.43 | 1.42 | |
| | | Co complex(0.1 wt %) | | | | | | |
| 10 | (Nd, Dy)₂Fe₁₄B | Hexane (C₆H₁₄), XeF₂(0.1 wt %), | <10 | 100 | 500 | 2.65 | 1.40 | |
| | | Ga complex(0.1 wt %) | | | | | | |
| 11 | (Nd, Dy)₂Fe₁₄B | Hexane (C₆H₁₄), XeF₂(0.1 wt %), | <100 | 100 | 500 | 2.35 | 1.39 | |
| | | SnF₂(0. [symbol] wt %) | | | | | | |
| 12 | (Nd, Dy)₂Fe₁₄B | Hexane (C₆H₁₄), XeF₂(0.1 wt %), | <10 | 100 | 500 | 2.45 | 1.38 | |
| | | DyF₃(0.01 wt %) | | | | | | |
| 13 | (Nd, Dy)₂Fe₁₄B | Hexane (C₆H₁₄), XeF₂(0.1 wt %), | <10 | 100 | 500 | 2.38 | 1.36 | |
| | | DyOF(0.01 wt %) | | | | | | |
| 14 | (Nd, Dy)₂Fe₁₄B | Hexane(C₆H₁₄), XeF₂(0.1 wt %), | <10 | 100 | 500 | 2.92 | 1.38 | |
| | | TbF₃(0.01 wt %) | | | | | | |
| 15 | Nd₂Fe₁₄B | — | — | — | — | 1.20 | 1.53 | Values before |
| 16 | Nd₂Fe₁₄B | Hexane (C₆H₁₄), X [symbol] F₂(0.5 wt %) | <10 | 100 | 500 | 1.85 | 1.55 | treatment in |
| 17 | Nd₂Fe₁₄B | Hexane (C [symbol] H₁₄), Xe₂F₃(0.5 wt %) | <10 | 100 | 500 | 1.88 | 1.55 | No. 16-50 |
| 18 | Nd₂Fe₁₄B | Hexane (C₆H₁₄), XeF₄(0.5 wt %) | <10 | 100 | 500 | 1.92 | 1.54 | |
| 19 | Nd₂Fe₁₄B | Hexane (C₆H₁₄), XeF₅(0.5 wt %) | <10 | 100 | 500 | 2.03 | 1.55 | |
| 20 | Nd₂F [symbol] ₁₄B | Hexane (C₈H₁₄), XoF₈(0.5 wt %) | <10 | 100 | 500 | 2.08 | 1.55 | |
| 21 | Nd₂Fe₁₄B | Hexane (C₆H₁₄), XeF₃(0.5 wt %) | <10 | 100 | 500 | 2.15 | 1.55 | |
| 22 | Nd₂Fe₁₄B | Hexane (C₆H₁₄), XoOF₄(0.5 wt %) | <10 | 100 | 500 | 1.89 | 1.55 | |
| 23 | Nd₂Fe₁₄B | Hexane (C₆H₁₄), XeF(0.5 wt %) | <10 | 100 | 500 | 1.82 | 1.55 | |

[symbol]

indicates data missing or illegible when filed

TABLE 1-2

| | | | Particle size | | | | | |
|---|---|---|---|---|---|---|---|---|
| | | | of fluoride | | Diffusion | | Residual | |
| | | | in treatment | Treatment | heat treatment | Coercive | magnetic | |
| | Material to | Main components in | solution | temperature | temperature | force | flux density | |
| No. | be treated | treatment solution | (μm) | (° C.) | (° C.) | (MA/m) | (T) | Remarks |
| 24 | Nd₂Fe₁₄B | Hexane (C₆H₁₄), XeF₂(0.5 wt %), | <10 | 100 | 500 | 1.97 | 1.55 | |
| | | XeF(0.5 wt %) | | | | | | |
| 25 | Nd₂Fe₁₄B | Hexane (C₆H₁₄), SbF [symbol] (0.5 wt %) | <10 | 100 | 500 | 1.95 | 1.55 | |
| 26 | Nd₂Fe₁₄B | Hexane(C₅H₁₄), XeF₂(0.5 wt %) | <10 | 100 | 500 | 1.91 | 1.55 | |
| | | ClF(0.5 wt %) | | | | | | |
| 27 | Nd₂Fe₁₄B | Hexane (C [symbol] H₁₄), BrF(0.5 wt %) | <10 | 100 | 500 | 1.81 | 1.55 | |
| 28 | Nd₂Fe₁₄B | Hexane (C [symbol] H₁₄),SiF₂(0.5 wt %) | <10 | 100 | 500 | 1.89 | 1.53 | |
| 29 | Nd₂Fe₁₄B | Hexane (C [symbol] H₁₄), SiF₄(0.5 wt %) | <100 | 100 | 500 | 2.35 | 1.53 | |
| 30 | Nd₂Fe₁₄B | Hexane (C₆H₁₄),HBF₄(0.5 wt %) | <100 | 100 | 500 | 2.35 | 1.52 | |
| 31 | Nd₂Fe₁₄B | Hexane (C₆H₁₄), BF₄(0.5 wt %) | <100 | 100 | 500 | 2.35 | 1.53 | |
| 32 | Nd₂Fe₁₄B | Methanol (CH₃OH), Al [symbol] F₁₂(0.1 wt %) | <100 | 150 | 500 | 1.35 | 1.54 | |
| 33 | Nd₂Fe₁₄B | Methanol (CH₃OH), Al₃F₁₀(0.1 wt %) | <100 | 100 | 500 | 1.38 | 1.53 | |
| 34 | Nd₂Fe₁₄B | Methanol (CH₃OH), Al₄F₂₀(0.1 wt %) | <100 | 100 | 500 | 1.42 | 1.53 | |
| 35 | Nd₂Fe₁₄B | Methanol (CH₃OH), Al₅F₂₈(0.1 wt %) | <100 | 100 | 500 | 1.48 | 1.54 | |
| 36 | Nd₂Fe₁₄B | Methanol (CH₃OH), Al₃F₂₀(0.1 wt %) | <100 | 100 | 500 | 1.58 | 1.53 | |
| 37 | Nd₂Fe₁₄B | Methanol (CH₃OH), Al [symbol] F [symbol] (0.1 wt %) | <100 | 100 | 500 | 1.61 | 1.54 | |
| 38 | Nd₂Fe₁₄B | Methanol (CH₃OH), CF₄(0.1 wt %) | <100 | 100 | 500 | 1.31 | 1.53 | |
| 39 | Nd₂Fe₁₄B | Methanol (CH₃OH), C₃F₆(0.1 wt %) | <100 | 100 | 500 | 1.29 | 1.55 | |
| 40 | Nd₂Fe₁₄B | Methanol (CH₃OH), C₄F₂(0.1 wt %) | <100 | 100 | 500 | 1.34 | 1.54 | |
| 41 | Nd₂Fe₁₄B | Methanol (CH₃OH), CaAlF [symbol] (0.1 wt %) | <100 | 100 | 500 | 1.58 | 1.53 | |
| 42 | Nd₂Fe₁₄B | Methanol (CH₃OH), BaAlF₅(0.1 wt %) | <100 | 100 | 500 | 1.75 | 1.53 | |
| 43 | Nd₂Fe₁₄B | Methanol (CH₃OH), Ba₃AlF₉(0.1 wt %) | <100 | 100 | 500 | 1.78 | 1.53 | |
| 44 | Nd₂Fe₁₄B | Methanol (CH₃OH), Na₅Al₃F₁₄(0.1 wt %) | <100 | 100 | 500 | 1.95 | 1.53 | |
| 45 | Nd₂Fe₁₄B | Methanol (CH₃OH), CCl₂F₂(0.1 wt %) | <100 | 100 | 500 | 1.35 | 1.55 | |
| 46 | Nd₂Fe₁₄B | Methanol (CH₃OH), CClF [symbol] (0.1 wt %) | <100 | 100 | 500 | 1.36 | 1.56 | |
| 47 | Nd₂Fe₁₄B | Methanol (CH₃OH), KAlF₄ (0.1 wt %) | <100 | 100 | 500 | 1.42 | 1.53 | |
| 48 | Nd₂Fe₁₄B | Methanol (CH₃OH), K₃AlF₆(0.1 wt %) | <100 | 100 | 500 | 1.39 | 1.53 | |
| 49 | Nd₂Fe₁₄B | Hexane (C₆H₁₄), NH₄HF(0.5 wt %) | <100 | 100 | 500 | 1.52 | 1.53 | |

[symbol]

indicates data missing or illegible when filed

TABLE 1-3

| | | | Particle size | | | | | |
|---|---|---|---|---|---|---|---|---|
| | | | of fluoride | | Diffusion | | Residual | |
| | | | in treatment | Treatment | heat treatment | Coercive | magnetic | |
| | Material to | Main components in | solution | temperature | temperature | force | flux density | |
| No. | be treated | treatment solution | (μm) | (° C.) | (° C.) | (MA/m) | (T) | Remarks |
| 50 | Nd₂Fe₁ [symbol] B | Hexane (C₆H₄), | <100 | 100 | 500 | 1.55 | 1.53 | |
| | | C₆F₅(0.5 wt %0) | | | | | | |
| 51 | Nd₂Fe₁₄B in which Dy is | — | — | — | — | 1.65 | 1.50 | Values before |
| | diffused in grain boundary | | | | | | | treatment in |
| 52 | Nd₂Fe₁₄B in which Dy is | Hexane (C₆H₄), | <10 | 120 | 450 | 1.84 | 1.48 | No. 52-60 |
| | diffused in grain boundary | SnF₂(0.1 wt %) | | | | | | |
| 53 | Nd₂Fe₁₄B in which Dy is | Hexane (C₆H₄), | <10 | 100 | 500 | 1.93 | 1.50 | |
| | diffused in grain boundary | XeF₂(0.1 wt %) | | | | | | |
| 54 | Nd₂Fe₁₄B in which Dy is | Hexane (C₆H [symbol] ), | <10 | 100 | 500 | 2.01 | 1.51 | |
| | diffused in grain boundary | XeF₂(0.5 wt %) | | | | | | |
| 55 | Nd₂Fe₁₄B in which Dy is | Hexane (C₅H₄), | <10 | 120 | 500 | 1.92 | 1.54 | |
| | diffused in grain boundary | XeF₂(0.5 wt %) | | | | | | |
| | | ClF(0.5 wt %) | | | | | | |
| 56 | Nd₂Fe₁₄B in which Dy is | Hexane (C₆H₄), | <10 | 120 | 500 | 2.31 | 1.55 | |
| | diffused in grain boundary | XeF₂(0.1 wt %), | | | | | | |
| | | GaF₃(0.01 w %) | | | | | | |
| 57 | Nd₂Fe₁₄B in which Dy is | Hexane (C₅ [symbol] ₄), | <10 | 120 | 500 | 2.26 | 1.56 | |
| | diffused in grain boundary | XeF₂(0.1 wt %), | | | | | | |
| | | TiF₃(0.01 wt %) | | | | | | |
| 58 | Nd₂Fe₁₄B in which Dy is | Methanol (CH₃OH), | <100 | 80 | 450 | 1.86 | 1.50 | |
| | diffused in grain boundary | XeF₂(0.1 wt %) | | | | | | |
| 59 | Nd₂Fe₁₄B in which Dy is | Ethanol (C₂H₃OH), | <100 | 80 | 450 | 1.87 | 1.50 | |
| | diffused in grain boundary | XeF₂(0.1 wt %) | | | | | | |
| 60 | Nd₂Fe₁₄B in which Dy is | Ethanol (C₂H₅OH), | <100 | 70 | 450 | 1.95 | 1.50 | |
| | diffused in grain boundary | XeF₂(0.1 wt %) | | | | | | |
| | | GaF₃(0.1 wt %) | | | | | | |
| 61 | Fe—24%Co14%Ni3%Cu9.2%Ti | — | — | — | — | 0.06 | 1.34 | Values before |
| 62 | Fe—24%Co14%Ni3%Cu9.2%Ti | Hexane (C₆H [symbol] ), | <1000 | 120 | 500 | 0.93 | 1.33 | treatment in |
| | | XeF₂(0.1 wt %) | | | | | | No. 62 |
| 63 | Fe—15%Co1.0%Ti24%Cr | — | — | — | — | 0.06 | 1.50 | Values before |
| 64 | Fe—15%Co1.0%Ti24%Cr | Hexane (C₆H₄), | <1000 | 120 | 500 | 0.95 | 1.48 | treatment in |
| | | XeF₂(0.1 wt %) | | | | | | No. 64 |
| 65 | BaO—6Fe₂O₃ | — | — | — | — | 0.21 | 0.41 | Values before |
| 66 | BaO—6Fe₂O₃ | Hexane (C₆H₄), | <1000 | 90 | 800 | 0.34 | 0.55 | treatment in |
| | | XeF₂(0.1 wt %) | | | | | | No. 66 |
| 67 | SrO—6Fe₂O₃ | — | — | — | — | 0.28 | 0.42 | Values before |
| 68 | SrO—6Fe₂O₃ | Hexane (C₆H₄), | <1000 | 80 | 700 | 0.35 | 0.53 | treatment in |
| | | XeF₂(0.1 wt %) | | | | | | No. 68 |
| 69 | Sr [symbol] La [symbol] Fe [symbol] Co [symbol] O [symbol] | — | — | — | — | 0.38 | 0.45 | Values before |
| 70 | Sr_{0.7}La_{0.3}Fe [symbol] Co [symbol] O [symbol] | Hexane (C₆H₄), | <100 | 150 | 900 | 0.55 | 0.52 | treatment in |
| | | XeF₂(0.1 wt %) | | | | | | No. 70-71 |
| 71 | Sr_{0.7}La_{0.3}Fe [symbol] Co [symbol] O [symbol] | Heptane (C₇H₁₆), | <10 | 140 | 700 | 0.83 | 0.56 | |
| | | XeF₂(5.0 wt %) | | | | | | |
| 72 | Sm(Co_{0.09}Fe_{0.20}Cu_{0.10}Zr_{0.01}) [symbol] | | | | | 0.55 | 1.10 | Values before |
| 73 | Sm(Co_{0.09}Fe [symbol] Cu_{0.1} [symbol] Zr_{0.01}) [symbol] | Hexane (C₆H₄), | <1000 | 80 | 700 | 1.12 | 1.11 | treatment in |
| | | XeF₂(0.1 wt %) | | | | | | No. 73 |

[symbol]

indicates data missing or illegible when filed

TABLE 1-4

| | | | Particle size | | | | | |
|---|---|---|---|---|---|---|---|---|
| | | | of fluoride | | Diffusion | | Residual | |
| | | | in treatment | Treatment | heat treatment | Coercive | magnetic | |
| | Material to | Main components in | solution | temperature | temperature | force | flux density | |
| No. | be treated | treatment solution | (μm) | (° C.) | (° C.) | (MA/m) | (T) | Remarks |
| 74 | Y₂Fe₁₄B | — | — | — | — | 0.75 | 1.32 | Values before |
| 75 | Y₂Fe₁₄B | Hexane, | <100 | 100 | 510 | 0.87 | 1.41 | treatment in |
| | | XeF₂(0.5 wt %) | | | | | | No. 75 |
| 76 | Mn—30%Al0.5%C | — | — | — | — | 0.22 | 0.60 | Values before |
| 77 | Mn—30%Al0.5%C | Hexane (C [symbol] H₁₄), | <1000 | 80 | 700 | 0.53 | 0.73 | treatment in |
| | | XeF₂(0.1 wt %) | | | | | | No. 77-79 |
| 78 | Mn—30%Al0.5%C | Hexane (C [symbol] H₁₄), | <10 | 120 | 600 | 0.54 | 0.76 | |
| | | XeF₂(0.01 wt%) | | | | | | |
| 79 | Mn—30%Al0.5%C | Hexane (C₆H₁₄), | <10 | 130 | 550 | 0.73 | 0.81 | |
| | | XeF₂(0.01 wt %), | | | | | | |
| | | NH₃(0.5 wt %) | | | | | | |
| 80 | Fe—50%Co | — | — | — | — | 0.05 | 1.90 | Values before |
| 81 | Fe—50%Co | Hexane (C₈H₁₄), | <1000 | 80 | 700 | 0.95 | 1.91 | treatment in |
| | | XeF₂(0.1 wt %) | | | | | | No. 81-85 |
| 82 | Fe—50%Co | Heptane (C₇H₁₆), | <100 | 100 | 500 | 1.36 | 1.92 | |
| | | XeF₂(5.0 wt %) | | | | | | |
| 83 | Fe—50%Co | Heptane (C₇,H₁₆), | <10 | 140 | 500 | 1.57 | 1.95 | |
| | | XeF₄(5.0 wt %) | | | | | | |
| 84 | Fe—50%Co | Heptane (C₇H₁₆), | <10 | 140 | 500 | 1.72 | 1.87 | |
| | | XeF₄(5.0 wt %), | | | | | | |
| | | TbF₃(0.1 wt %) | | | | | | |
| 85 | Fe—50%Co | Heptane (C [symbol] H₁₆), | <10 | 180 | 450 | 1.15 | 1.75 | |
| | | SnF₂(5.0 wt %) | | | | | | |
| 86 | Fe—25%Co | — | — | — | — | 0.05 | 1.97 | Values before |
| 87 | Fe—25%Co | Hexane (C [symbol] H₁₄), | <1000 | 80 | 700 | 0.87 | 2.02 | treatment in |
| | | XeF₂(0.1 wt %) | | | | | | No. 87-88 |
| 88 | Fe—25%Co | Heptane (C [symbol] H₁₆), | <10 | 140 | 500 | 1.25 | 1.96 | |
| | | XeF₄(5.0 wt %), | | | | | | |
| | | TbF₃(0.1 wt %) | | | | | | |
| 89 | Fe—52%Co—8%V—4%Cr | — | — | — | — | 0.04 | 1.21 | Values before |
| 90 | Fe—52%Co—8%V—4%Cr | Heptane (C₇H₁₆), | <100 | 130 | 400 | 0.58 | 1.24 | treatment in |
| | | XeF₂(5.0 wt %) | | | | | | No. 90 |
| 91 | MnBi | — | — | — | — | 0.97 | 0.65 | Values before |
| 92 | MnBi | Hexane (C₆H₁₄), | <10 | 80 | 600 | 1.15 | 0.88 | treatment in |
| | | XeF₂(0.01 wt %) | | | | | | No. 92-93 |
| 93 | MnBi | Hexane (C₆H₁₄), | <10 | 120 | 600 | 1.28 | 0.95 | |
| | | XeF₂(0.01 wt %) | | | | | | |
| | | NH₃(0.5 wt %) | | | | | | |
| 94 | Ni₃Fe | — | — | — | — | 0.01 | 0.51 | Values before |
| 95 | Ni₃Fe | Hexane (C₆H₁₄), | <10 | 150 | 800 | 0.86 | 0.75 | treatment in |
| | | XeF₂(0.01 wt %) | | | | | | No. 95 |
| 96 | Fe₃Ga | — | — | — | — | 0.02 | 0.47 | Values before |
| 97 | F [symbol] Ga | Hexane (C₆H₁₄), | <10 | 150 | 800 | 0.71 | 0.65 | treatment in |
| | | XeF₂(0.01 wt %) | | | | | | No. 97 |

[symbol]

indicates data missing or illegible when filed

TABLE 1-5

| | | | Particle size | | | | | |
|---|---|---|---|---|---|---|---|---|
| | | | of fluoride | | Diffusion | | Residual | |
| | | | in treatment | Treatment | heat treatment | Coercive | magnetic | |
| | Material to | Main components in | solution | temperature | temperature | force | flux density | |
| No. | be treated | treatment solution | (μm) | (° C.) | (° C.) | (MA/m) | (T) | Remarks |
| 98 | Fe₃Si | — | — | — | — | 0.01 | 0.87 | Values before |
| 99 | Fe₃Si | Hexane (C₆H₁₄), XeF₂(0.01 wt %) | <10 | 140 | 600 | 0.74 | 0.88 | treatment in |
| | | | | | | | | No. 99 |
| 100 | Fe₃Al | — | — | — | — | 0.01 | 0.79 | Values before |
| 101 | Fe₃Al | Hexane (C [symbol] H₁₄), XeF₂(0.01 wt %) | <10 | 130 | 600 | 0.93 | 0.8 [symbol] | treatment in |
| | | | | | | | | No. 101 |
| 102 | FeMn | — | — | — | — | <0.01 | <0.02 | Values before |
| 103 | FeMn | Hexane (C₆H₁₄), XeF₂(0.01 wt %) | <10 | 130 | 600 | 0.52 | 0.65 | treatment in |
| | | | | | | | | No. 103 |
| 104 | FePt | — | — | — | — | 0.60 | 0.75 | Values before |
| 105 | FePt | Hexane (C [symbol] H₁₄), XeF₂(0.1 wt %) | <10 | 120 | 600 | 0.97 | 0.89 | treatment in |
| | | | | | | | | No. 105 |
| 106 | CoFe₂O₄ | — | — | — | — | 0.25 | 0.32 | Values before |
| 107 | CoFe₂O₄ | Hexane (C [symbol] H₁₄), XeF₂(0.5 wt %) | <1000 | 150 | 450 | 0.28 | 0.37 | treatment in |
| 108 | CoFe₂O₄ | Phenol (C₆H [symbol] OH), XeF₂(0.5 wt %) | <1000 | 150 | 500 | 0.35 | 0.48 | No. 107-108 |
| 109 | Fe_{0.25}TaS₂ | — | — | — | — | 0.32 | 0.21 | Values before |
| 110 | Fe_{0.25}TaS₂ | Hexane (C [symbol] H₁₄), XeF₂(0.5 wt %) | <10 | 100 | 500 | 0.45 | 0.25 | treatment in |
| 111 | Fe_{0.25}TaS₂ | Ethanol (C₂H₅OH), XeF₂(0.1 wt %) | <1 | 70 | 450 | 0.55 | 0.32 | No. 110-111 |
| 112 | Co₃C | — | — | — | — | 0.40 | 0.05 | Values before |
| 113 | Co₃C | Hexane (C [symbol] H₁₄), XeF₂(0.5 wt %) | <10 | 100 | 400 | 0.43 | 0.16 | treatment in |
| 114 | Co₃C | Ethanol (C₂H₅OH), XeF₂(0.1 wt %) | <1 | 60 | 350 | 0.48 | 0.36 | No. 113-114 |
| 115 | Fe₃Se₄ | — | — | — | — | 0.40 | 0.05 | Values before |
| 116 | Fe₃Se₄ | Hexane (C [symbol] H₁₄), XeF₂(0.5 wt %) | <10 | 120 | 450 | 0.51 | 0.07 | treatment in |
| 117 | Fe₃Se₄ | Ethanol (C₂H₅OH), XeF₂(0.1 wt %) | <1 | 60 | 500 | 0.64 | 0.21 | No. 116-117 |
| 118 | LaSmMnO₄ | — | — | — | — | 0.16 | 0.29 | Values before |
| 119 | LaSmMnO₄ | Hexane (C₅H₁₄) XeF₂(0.5 wt %) | <100 | 150 | 600 | 0.24 | 0.31 | treatment in |
| 120 | LaSmMnO₄ | Phenol (C₆H₅OH), XeF₂(0.5 wt %) | <100 | 80 | 650 | 0.36 | 0.48 | No. 119-120 |
| 121 | Fe₄N | — | — | — | — | 0.02 | 1.40 | Values before |
| 122 | Fe₄N | Hexane (C₆H₁₄), XeF₂(0.5 wt %) | <2000 | 150 | 350 | 0.13 | 1.41 | treatment in |
| 123 | Fe₄N | Hexane (C [symbol] H₁₄), XeF₂(0.5 wt %) | <2000 | 120 | 350 | 0.35 | 1.47 | No. 122-124 |
| | | SmF₃(0.5 wt %) | | | | | | |
| 124 | Fe₄N | Ethanol (C₂H₅OH), XeF₂(0.5 wt %) | <0.01 | 60 | 400 | 0.41 | 1.57 | |

[symbol]

indicates data missing or illegible when filed

TABLE 2

| | | | | Unevenly | Main grain |
|---|---|---|---|---|---|
| | Material to | Diffusing | Treatment | distributed | boundary |
| Magnet | be difused | material | temperature | element | phase |
| Dy vapor | Nd₂Fe₁₄B- | Dy | 800° C. | Dy | (Nd, Dy)₂O₃₋ₓ |
| grain | based sintered | | or more | | |
| boundary | magnet | | | | |
| diffusion | | | | | |
| magnet | | | | | |
| Tb-based | Nd₂Fe₁₄B- | TbF₃ etc. | 600° C. | Tb, F | (Nd, Tb)OF |
| grain | based sintered | | or more | | |
| boundary | magnet | | | | |
| diffusion | | | | | |
| magnet | | | | | |
| Fluorinated | Nd₂Fe₁₄B- | Fluorine | 50~400° C. | Fluoride-forming | NdOₓF_{y}(y > x) |
| magnet | based sintered | (F) | | element contained | |
| | magnet | | | in magnet before | |
| | | | | F-treatment | |

### REFERENCE SIGNS LIST

1 Main phase crystal grain
3 Grain boundary phase
4 Fluorine-containing phase at grain boundary triple point
5 Peripheral part

1. A sintered magnet comprising an NdFeB main phase and a grain boundary phase, wherein
the grain boundary phase contains an oxyfluoride;
a concentration of fluorine in the oxyfluoride decreases depthwise from a surface of the sintered magnet toward a center of the sintered magnet; and
a concentration of a heavy rare earth element contained in the oxyfluoride at the surface of the sintered magnet is nearly equal to that at the center of the sintered magnet.

2. The sintered magnet according to claim 1, wherein
a concentration of an additive element detected in an area of 100×100 μm² at the surface of the sintered magnet is nearly equal to that at the center of the sintered magnet, and
a concentration of the additive element detected in an area of 10×10 nm² at the surface of the sintered magnet is higher than that at the center of the sintered magnet.

3. The sintered magnet according to claim 1, wherein the additive element is at least one element selected from the group consisting of Al, Cu, Ti, Zr, Mn, Co, Sn, Si, Cr, V, Ga, and Ge, and the additive element is unevenly distributed in the grain boundary phase.

4. The sintered magnet according to claim 1, wherein the concentration of fluorine in the oxyfluoride is higher than 33 atom % in terms of an average value in a region within 100 μm depthwise from the surface of the sintered magnet.

5. The sintered magnet according to claim 1, wherein the oxyfluoride comprises a cubic or tetragonal crystal structure.

6. The sintered magnet according to claim 1, containing a metal element having a lower fluoride-forming energy than Cu in a concentration range of 0.1 to 5 wt %.

7. The sintered magnet according to claim 1, wherein a fluorine content of the whole sintered magnet is 5 atom % or less.

8. The sintered magnet according to claim 1, wherein a concentration of oxygen in the whole sintered magnet is 3000 ppm or less.

9. A process for producing a sintered magnet according to claim 1, comprising: using a dissociative fluorinating agent to selectively introduce fluorine into the grain boundary phase of the sintered magnet.
